(19) United States
(12) Patent Application Publication
(10) Pub. No.: US 2013/0020309 A1
(43) Pub. Date: Jan. 24, 2013

(54) Carton and Temperature Control System

(71) Applicants: Edwin Francis Tattam, North Cheriton (GB); Arthur Smith-Fitchett, Cuddesdon (GB)

(72) Inventors: Edwin Francis Tattam, North Cheriton (GB); Arthur Smith-Fitchett, Cuddesdon (GB)

(73) Assignee: SOFTBOX SYSTEMS LIMITED, Long Crendon (GB)

(21) Appl. No.: 13/555,374

(22) Filed: Jul. 23, 2012

(30) Foreign Application Priority Data
Jul. 22, 2011 (GB) 11112261.2
Mar. 21, 2012 (GB) 1204976.3

(51) Int. Cl. H05B 1/00

(52) U.S. Cl. 219/441

(57) ABSTRACT

The present invention relates to a temperature control system for cartons, such as transport cartons which are employed to transport goods in aircraft, and to cartons fitted with the same. Food and pharmaceutical products require temperature stability during transportation; otherwise goods can be damaged and be unusable, whether such damage is apparent or not. Goods can be transported in tropical heat, packaged and may be left on runways at extreme temperatures and then placed within a hold where low pressures and low temperatures exist during flight. The invention seeks to provide a simple to fabricate temperature control system for a carton which can retain goods reliably at a specified temperature. The invention also provides a powered monitor system is provided whereby to ensure that extreme temperature excursions in transport can be provided by a simple to use container insert.

### FIELD OF INVENTION

The present invention relates to a temperature control system for cartons, such as transport cartons which are employed to transport goods in aircraft and urgent delivery services. In particular, the present invention relates to a carton with a temperature control system, for the transport of temperature-critical supplies.

### BACKGROUND TO THE INVENTION

In the field of logistics, that is the field of movement and supply of produce and materials, in particular in the transport of intermediate and finished products, containers and cartons have been developed which safely protect from physical damage a wide variety of product. However, certain types of products, such as food and pharmaceutical products not only need protection from physical shock and pressures but also require temperature stability during transportation; otherwise goods can be damaged and be unusable, whether such damage is apparent or not.

For example, in the pharmaceutical industry, product often needs to be maintained within a temperature range: product may be packed in relatively small containers or cartons which are typically provided in standard sizes of 7, 13 & 28 Litres in volume. These containers are relatively fragile—accordingly insulation must provide both physical and thermal stability. Equally, in the food industry, fish suppliers will often have chilled fish boxes which are designed to accept, say 20 Kg of product. The fish must be maintained at low temperatures, yet will be placed in containers which require a high degree of strength to prevent spillage.

In developed markets, for example in Europe and North America, foods grown in other continents, with distinctly different climates and considerable diurnal temperature ranges—are increasingly being stocked by supermarkets, delicatessens and the like. Short pick to distribution centre times in the producing country are matched by air carriers taking goods to the countries of consumption in similar lengths of time, whereby it is not uncommon for fruit to be on the plates of householders within two to three days of having been picked in a distant country.

However, air transport poses a particular problem: Goods can be packaged and placed upon pallets and the like containers whereby they are presented in aircraft style containers. Such goods may be left on runways at extreme temperatures (−20° C.) and then placed within a hold where low pressures and low temperatures exist during flight. At a destination airport the temperatures may well be above 0° C. In the case of the transport of temperature sensitive pharmaceuticals the pharmaceuticals must be transported within a specific temperature range, such pharmaceuticals typically being transported in relatively small boxes.

Transport managers need volume to enable goods to be transported, effective temperature control systems take up space, a problem compounded in the case of air haulage, where containers should weigh little and make use of non-rectangular hold spaces within aircraft. Additionally goods, they must be protected from shock. Where good must be transported within a narrow temperature range, there may be a requirement for temperature data loggers whereby a record of temperature within a container may determine whether or not a pharmaceutical is destroyed prior to use because of poor temperature handling. Refrigeration units may be provided as an integral component of a container whereby temperatures maybe maintained, but then a source of electrical power or fuel for a powered generator is required. An example of such a temperature control system is shown in CN20136863 to Hefei Midea Royalstar Refrigeration Company. Moreover, the temperature of a particular carton cannot be monitored and recorded as a specific temperature log or record.

To simplify transportation of goods with respect to airports, planes and handling equipment, there have been developed aircraft Unit Load Devices (ULDs) which comprise any type of pallet or container that can easily be loaded to the aircraft by a ground handler. Aircraft ULDs are units which interface directly with an aircraft loading and restraint system, without the use of supplementary equipment. There are pre-defined ULDs, such as LD3, LD7, which correspond to standard configurations and can be utilised on certain types of aircraft. KR 20080100401 provides a multi combined packing container is provided to improve the products value of the fresh food through low temperature refrigeration circulation in the current fresh food circulation system and comprises first, second, third and fourth packing materials, wherein the third packing material is a form of refrigerant pack and is inserted inside the second packing material; the fourth packing material is inserted inside the third packing material. Other known forms of chilling products such as ice packs comprise polymer coolants packaged within bags can provide simple means to cool products. However, in the nature of transport containers, the gel packs can move or otherwise become dislodged from a selected place whereby a temperature gradient can occur, whereby a required temperature for a medicine, vaccine, food or other temperature critical product is damaged. Again, no carton specific data log can be provided nor can the temperature thereof be controlled in a specified band.

Applicants have developed a container systems that benefits from providing a closed atmosphere when assembled yet capable of being easily dismantled. Thick insulating panels enable passive temperature control. Such a container is disclosed in granted patent GB2459392. Detachable coolant means are provided in GB2470662, where coolant means are inserted into a coolant sleeve prior to closure of a unit load transport container. These containers and coolant means have been found to be remarkably resilient in use and operate, ordinarily within a temperature range of 0° C.-30° C. There is a requirement for a similar passive container control system for use of such systems in northerly climates such as the Baltic countries during cold periods.

It is notable that there are few passive thermal exchange devices for cargo containers—air-conditioning motors and refrigeration units needing power to maintain operation, which might not be possible within many cargo handling and distribution centres; few can remain where placed during transport as a matter of course.

In summary, there is exists a need for temperature control systems for containers that allow an independence of movement through a courier's global logistics network, provides a minimal degree of intrusion into an existing product load voids, in order to maximise available product load space, that provides selective provision of full thermal protection of a product load, that can be simply installed, simply operated and simply maintained, and that is economically viable.

### OBJECT OF THE INVENTION

The present invention seeks to provide a solution to the problems addressed above. The present invention seeks to provide a temperature control system for controlled temperature transport cartons which can be manufactured at low cost and can readily and easily be constructed, from, as is typical, a flat-pack arrangement of a bases, sides and a top to a container.

The present invention seeks to provide a heating system operable to maintain a minimum temperature either in a box or carton.

### STATEMENT OF INVENTION

In accordance with a general aspect of the invention, there is provided a box or carton having an inside base, at least one inside wall from the base, a cover and a temperature control system, the system comprising an insert that is operably inserted within the container and including a base panel, at least one side wall panel, a heater, temperature sensing means and a control unit; wherein the heater is arranged within at least one of the base and a side wall of the insert; Wherein the temperature sensing means is arranged to measure the temperature of at least one position within a complete carton and the control means is arranged to cause the heater to operate upon meeting a temperature threshold; wherein the base and at least one side wall of the insert define a convection manifold, such that upon operation of the heater, gaseous convection currents cause transfer of heat whereby to maintain the inside temperature of the carton above an operational minimum temperature.

Conveniently, the temperature sensing means comprises at least one thermister. The temperature sensing means can comprises a single thermister located within the base and is thermally isolated from the heater. The thermister can be calibrated to provide a likelihood of temperature excursion whereby the control means switches the heater units into an operational mode. Several thermisters can be employed, whereby all or selected vulnerable parts of the container are protected from threshold temperature excursion. The heater can be placed within the base. The heater can be placed within a lower section of a side wall. The controller may take an average or weight the inputs from the sensors prior to activating the heater.

Conveniently both the controller and heater are provided with independent power supplies; the power supplies for the heater elements are conveniently rechargeable and replaceable.

The convection manifold can be determined, at least in part, by channels of corrugation defined in the inserts, for example, comprising corrugated plastics or fibreboard inserts.

The convection manifold can be determined from moulded plastics materials, such as expanded polyvinylchloride (PVC), polystyrene or general purpose polystyrene (GPPS), polymethylpentene (PMP) etc. Rebates or corrugations within the inserts may be placed against the inside walls of the container, whereby to define convection channels or passages by the juxtaposition of the inserts and walls. Further, an advantage arising from the use of materials such as polyethylene foam means that thermal insulation and physical shock protection is increased.

Conveniently, the control means comprises a data logging device; data can be transferred to characterise temperature profiles for the transport of goods. Alternatively or additionally, the control means may provide data by wireless means.

In another aspect of the invention, there is provided a temperature control system for a carton.

A carton insert in accordance with the present invention may be assembled in a rapid and expeditious manner. The parts making up the temperature control system generally comprise integral components of inserts to a box or carton, whereby the insert can be flat packed, whereby to reduce space; the box may be stacked for storage in a relatively small space, prior to and subsequent to actual use.

The use of cartons in accordance with the present invention can enable transport of temperature-critical to be provided using non-premium rate transport providers and freight handling systems. Accordingly the cost of the carton and packaging can be recouped by using less costly transport providers.

### BRIEF DESCRIPTION OF THE FIGURES

For a better understanding of the present invention, reference will now be made, by way of example only, to the Figures as shown in the accompanying drawing sheets, wherein:

FIGS. 1a-1c and 2a & 2b illustrate prior-art transport cartons and box-containers;

FIGS. 3a & 3b detail a coolant envelope assembly for placement upon an inside wall of a transport container;

FIG. 4 shows an exploded view of the heating and control means of one embodiment of the invention;

FIG. 5 shows a cardboard blank of an insert in accordance with a first embodiment;

FIGS. 5a & 5b show, in accordance with the first embodiment of the invention, an underside of a base panel and the insertion of an insert within a transport box, respectively;

FIGS. 6a & b show details of a fold of the first embodiment;

FIG. 7 shows a formed plastics blank of an insert in accordance with a second embodiment; and,

FIG. 8 shows a plastics insert within a carton, in accordance with a second embodiment of the invention;

FIGS. 8a-8c show different views of the second embodiment;

FIG. 9 shows an alternative polyester heater element;

FIGS. 10-10b show a still further embodiment;

FIGS. 11a-11c shows an insert according to FIG. 10;

FIG. 11d shows an insert according to FIGS. 11a-11c in a winter-pack out configuration;

FIGS. 12a & 12b show graphs of temperature over time in temperature; and,

FIGS. 13a & 13b show comparison graphs demonstrating specific advantages of the present invention.

### DETAILED DESCRIPTION OF THE PREFERRED EMBODIMENTS

There will now be described, by way of example only, the best mode contemplated by the inventor for carrying out the present invention. In the following description, numerous specific details are set out in order to provide a complete understanding to the present invention. It will be apparent to those skilled in the art, that the present invention may be put into practice with variations of the specific.

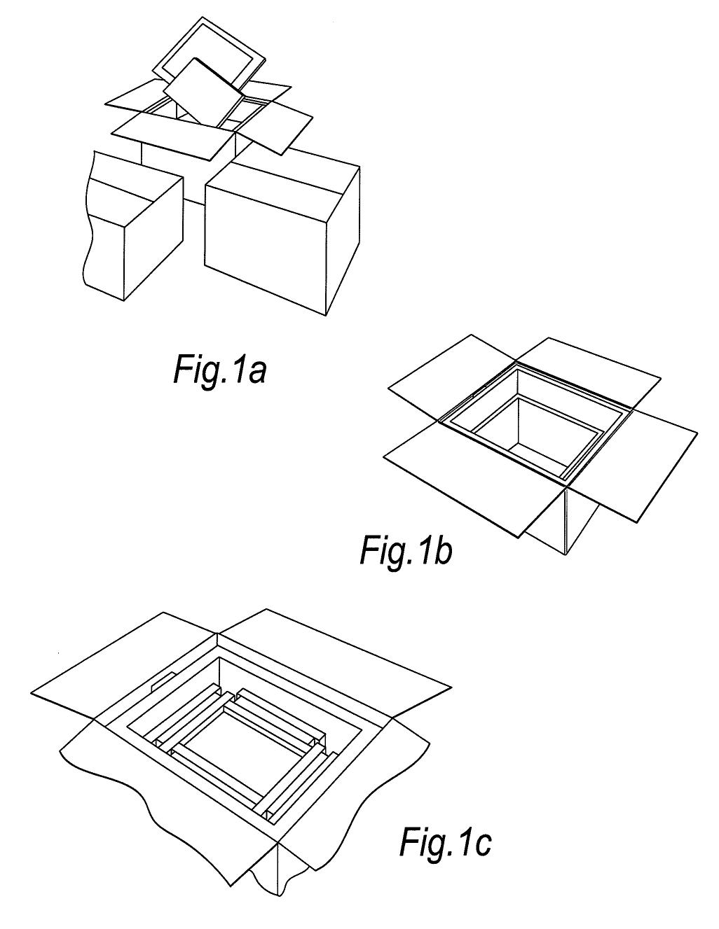

Applicant Company presently provides cartons which can provide an enclosed environment of up to 96 hours at a temperature of between 2° C. and 8° C. or between 15° C. and 25° C. Internal walls comprising expanded polystyrene (EPS) insulation are arranged within a corrugated fibreboard shell; a coolant gel-pack is placed above an internal box and this has been found to work well within the design specification; cartons of 7, 13 and 28 litres payload space are provided. Larger cartons can be provided with extended 120 hour specifications, also within the industry standard temperature ranges. FIG. 1a shows a completed opened box with coolant packs arranged within a wall section of insulation. FIGS. 1a and 1c show two cartons with differing configurations for the placement of coolant packs; FIG. 1c shows how a further, product box, is placed within a series of spacers and coolant packs. The coolant packs, as is known, contain a product with a high thermal capacity, which is placed within the carton to be maintained within a particular temperature range for a given range of external temperatures, the insulation; the temperature control packs being selected to maintain the product within said temperature range.

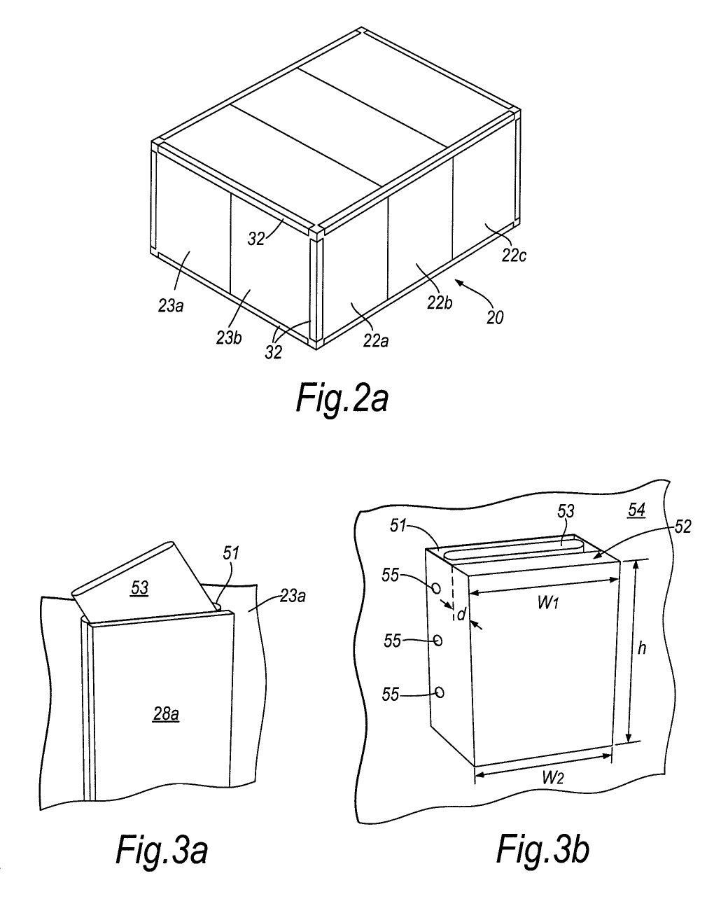

FIG. 2a shows an example of a container as is disclosed in GB2459392B in an assembled state. Whilst a base panel is not shown in any detail, side panel members 22a-c & 23a, b are arranged such that a lower edge portion of the panel members are engaged in rebates defined by the base member. Conveniently, and as claimed in this invention, the rebate is defined between the base member and “L” section elements attached to the base member. The corners of the rectangular container are arranged in mutually similar rebate and edge panel connection. In use, for example, as an LD7 container, the container panels are mounted upon a pallet and then an aluminium base which conforms to the specification of International aircraft standards; elasticated webbing 26 is attached via plugs which locate in a perimeter rail of the base.

Turning now to FIG. 2b, there is shown an exploded view of the container as shown in FIG. 2a. The load is contained in boxes 41, mounted upon pallets 42. Each box 41 is a box with temperature sensitive contents; it needs to be maintained within a specific, limited temperature range. The base, side and top panels may all be manufactured from plastics foam sheets, such as extruded polystyrene or polyurethane, conveniently sheathed for strength and durability with, for example, polypropylene sheeting or other types of sheathing. In use, the containers can be disposed of after their first use, due in part to the one-way nature of the cargo involved, be it agricultural produce, say from farms in Africa to Europe or the delivery of pharmaceutical goods. This container provides a simple to fabricate container which can retain goods reliably within a specific temperature range, achieved, in part, through the use of suitable gel packs filled with substances with a high thermal capacity, together with the inherently low thermal conductivity of the container and the relative air-tightness of the joins between the panels.

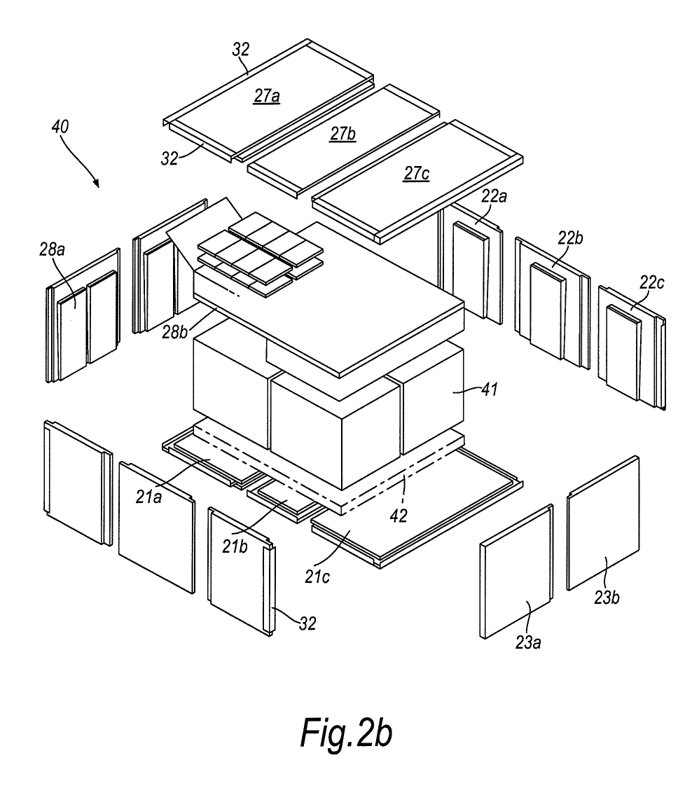

The sleeves or envelopes 28a attached to the inside walls of the container per FIG. 2b are shown in greater detail in FIGS. 3a and 3b. These sleeves comprise containment means for temperature control packs, such as gel packs, for example, which have a high heat capacity whereby to assist in the maintenance of a particular temperature. Such temperature control packs are suitable where the ambient temperatures exceed the desired temperature of transportation. However, these systems are passive and rely upon an industry-leading degree of thermal stability. It will be appreciated that the use of such temperature control packs benefit from the thermal capacity and volumetric displacement of a large container, which a carton does not possess.

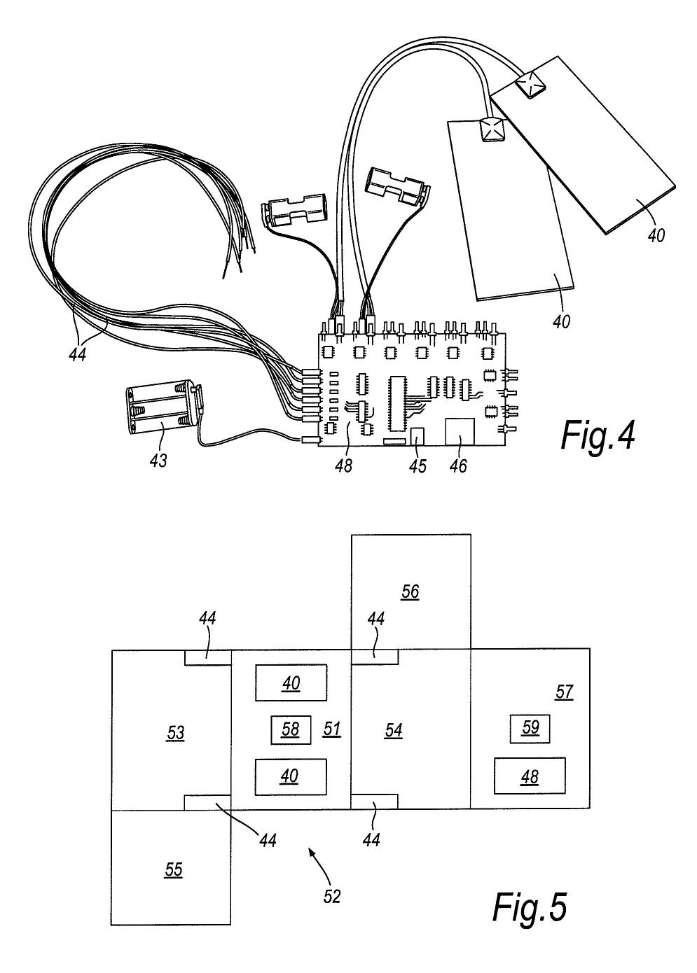

FIG. 4 shows one aspect of the invention comprising a heat pack and controller. Heat pads 40 are connected by low resistance wires to control board 48. Control board—which can comprise a flexible pcb—is a versatile controller having a number of output sockets 43a-f. Thermisters 44 a-e are arranged to be placed in preferred positions of a carton or container whereby to determine a specific temperature with regard to a class of good to be transported. The controller is connected to a battery pack; the heaters are conveniently provided with specific electric energy storage cells, conveniently replaceable rechargeable units which are replaced for each placement of an insert within a container or carton. Conveniently the controller is provided with data transfer means for example, but not limited to, SD—data storage means 45 or a usb link 46. The controller can also be connected to a fan for certain environments where convection cooling (to be described below) is not sufficient. The heater units are placed within channels

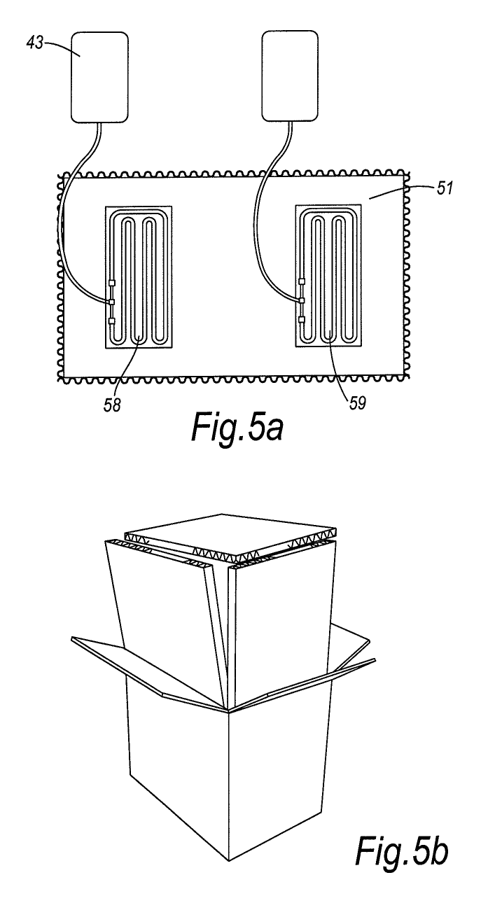

FIG. 5 shows a cardboard blank of a carton in accordance with a first aspect of the invention. Heater elements 51 are retained within the base face of the carton 52; sides 53 and 54 depend from first and second long sides of the base; sides 55 and 56 depend from sides 53 and 54 respectively, whilst a lid to the carton, 57 depends from the second long edge of side 54. The heater units 40 are accessible from the underside of the base panel and can enable convection currents to develop in the corrugation channels, the alignment of such channels being from long side to long side, whereby convection currents may flow from the heater, in a manifold fashion through the corrugations from the base and upwardly through the sidewall panels, whereby to evenly, without temperature spikes, heat the insert carton. Thermisters 44 are conveniently inserted within the corrugations so that they are disposed at the four lower corners of the insert carton, such that they measure the air temperature within a channel or other recess. Electrical cells 43 provide electrical energy for the heaters can be placed in the spaces cut out in the base 51 and top 57, for the heaters 40 and control means 48, respectively. For convenience the wires connecting the various thermisters, power supply and heater elements have not been shown, but such wires can be simply be placed upon an outside faces of the carton during assembly, after attachment to respective sockets to enable control.

FIG. 5a shows an underside view of a base panel of a carton in accordance with the invention. The base is provided with two separate heater circuits. FIG. 5b shows how a completed carton insert is placed within an outer box. This method of providing an extreme temperature heating system to controlled temperature transportation can easily be adapted to larger containers such as unit load devices.

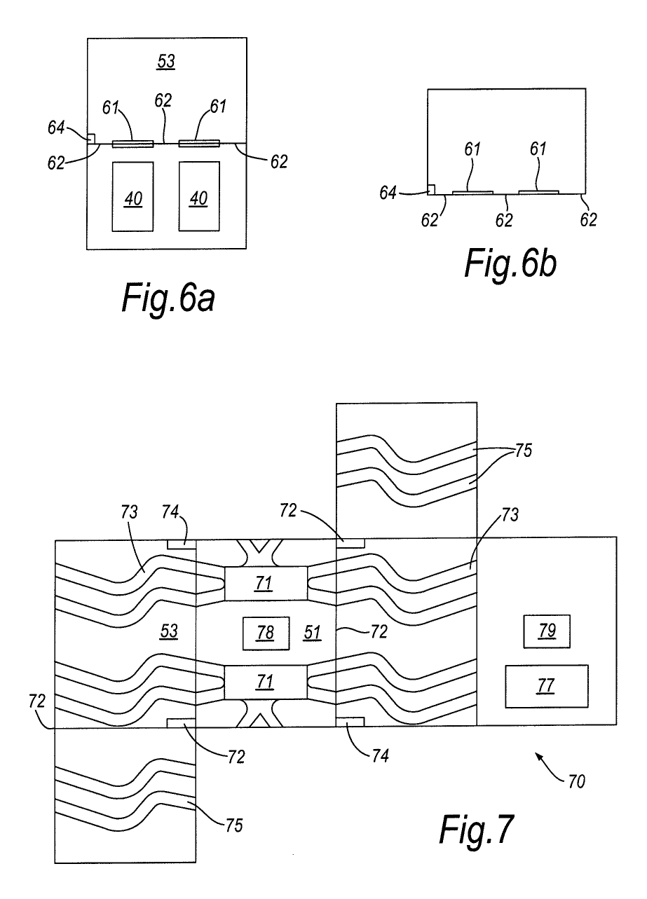

With reference to FIGS. 6a and 6b, it has been found that during manufacture of the cardboard blank, a cut is defined 61 or a narrow blank removed about the edges of bending 62, for example between the long sides of, for example, portions 51 and 53, such that the cardboard is reliably bent along the correct fold line and to enable the manifold not to be occluded by a compressed outside edge of fibreboard. With reference to FIG. 6b, especially, it can be seen once two panels have been folded, the ends of the exposed corrugations 64 are not deformed at all and convected air is free to pass through the side wall 53, in use. Obviously air can pass down other channels of the corrugation to ensure a flow of air within the convection cycle. In the alternative, inserts of rigid plastics material (for example) with channels or passageways can be placed, to ensure continuity of the manifold.

The heater units are conveniently low voltage heater pads as are commonly used in heated garments; these types of heater are flexible and can withstand repeated use and are sealed so that they are both waterproof and durable. The present invention, in a preferred embodiment, utilises polyester heating elements and it has been found that a pair of 3V, 3 W polyester heating foils of 0.6 mm in thickness operate well in typical conditions. These heating elements can be powered by small batteries such as lithium-ion batteries or similar and provide sufficient heating for half an hour or longer, dependent upon temperature increase required and the areas of the blanket being heated. A typical unit could comprise, for example, a rechargeable 3V, 4400 mAh lithium-ion battery and such an electrical battery can provide sufficient electrical energy to heat a basic circuit with 6 pairs of heating elements on a maximum heat setting for 2.5 hours and 7 hours on a minimum setting. In the alternative, fresh, non-rechargeable batteries may be employed: these batteries could be inserted as a matter of course, whereby new batteries are always employed, as a precaution. Notwithstanding this, a procedure could be put in place such that batteries are always checked so that they achieve a minimum output prior to deployment of a heater insert, whether rechargeable or not. A control circuit will be provided separately, with its own electrical power: The controlling circuit board (arranged on its own pcb) is conveniently powered by a lithium coin electrical cell e.g. CR232 that will lay dormant until the user activates the system by pressing and holding the micro-switch until the green indication LED housed in the lid of the device illuminates and holds for a number of seconds. It is intended that a coin electrical cell is likely to be the determining factor in determining shelf life of the product. Typically, a new production battery will last an estimated 15/20 years. It is likely that a shelf life of approximately 2-5 years would be required and extrapolations of initial trials mean that a realistic shelf life far in excess of this is possible.

The control circuit comprises a micro processor that is programmed with hard wired logic that will allow the invention to perform in a number of modes. An input data device can enable appropriate but limited adjustment of any programming that may be necessary. Conveniently, SD recording devices are provided for simple and accurate data transfer, to enable verification of a temperature profile for a particular transport event. The user will operate the device by utilising a micro switch which will be located within the lid of the insert. This micro switch will form part of a small electrical circuit that will include at least one indicator LED, whereby to confirm operation of the device. Variants can simply be made; for example, a two LED system could be implemented, conveniently the LEDs having different colours: A green LED could indicate to a user of the invention that the system was operational or was capable of operating; a red LED could indicate that the system was either faulty or for the end receiver to know that the present invention had been activated during the transportation cycle.

A carton in accordance with the present invention can also be programmed with a diagnostic facility to enable a user to determine whether the system is operable prior to the use of the carton and, particularly, prior to any packaging of the product. For example, a diagnostic test could be performed to ensure that the integrity of the board and components, ensure the heat pads are working and check the sufficiency of power that the electrical cells. Such a test could conveniently be performed by pressing a micro switch once or a number of times (as programmed to a particular requirement). For example, the diagnostic test could be performed at any point before the system is armed by pressing a micro switch once, and a green LED would flash briefly to indicate that the system is ok. Should the diagnostic test prove unsatisfactory then the system would shutdown and indicate via, for example, a single red LED, which would remain illuminated until expiry of the electrical cell for the circuit, whereby to ensure the user knows not to use the system for any reason.

To arm the device in accordance with the invention, the user would need to operate the micro-switch—or micro-switches—in accordance with a specified routine. A carton in accordance with the present invention will continue to sense internal temperatures and operate the heating foils as necessary until the power of the electrical power cell has exhausted, or by way of catastrophic failure in the integrity of the electrical system, indicating the status of the system per one or more LEDs, as indicated above.

Conveniently, the device will have a fail-safe condition that will force the system to deactivate and shut down should there be any problem such as damage caused to the device. This has been taken into account by providing safety features in view of some fears that have been expressed concerning the transportation of lithium batteries.

For a typical carton, it has been found that it is sufficient to have a thermister sensor to be placed at each of the four base corners of a carton. Temperature readings determined from sensors such as thermisters can determine when there is a need to increase the temperature of the base and the heaters are switched on. One sensor may be suitable for certain requirements, whereas more than four sensors may also be applied. The heater may operate following a low temperature excursion for only one sensor or may operate following a weighted calculation of outputs from a number of thermisters. It has been found that convection currents are generated by temperature differences as small as 0.3° K and that the heat generated can generate sufficient heat within ten minutes or so to counteract a possible temperature excursion outside of what would otherwise be an operational limit on an unheated carton.

Accordingly, by activating the heater at appropriate times, the controller can maintain a minimum temperature with a transport carton, irrespective of the climate external to the container. A thermister element employed to control the temperature can be accurate to within ±0.5° C. which is a typical requirement for in the pharmaceutical industry standard accuracy.

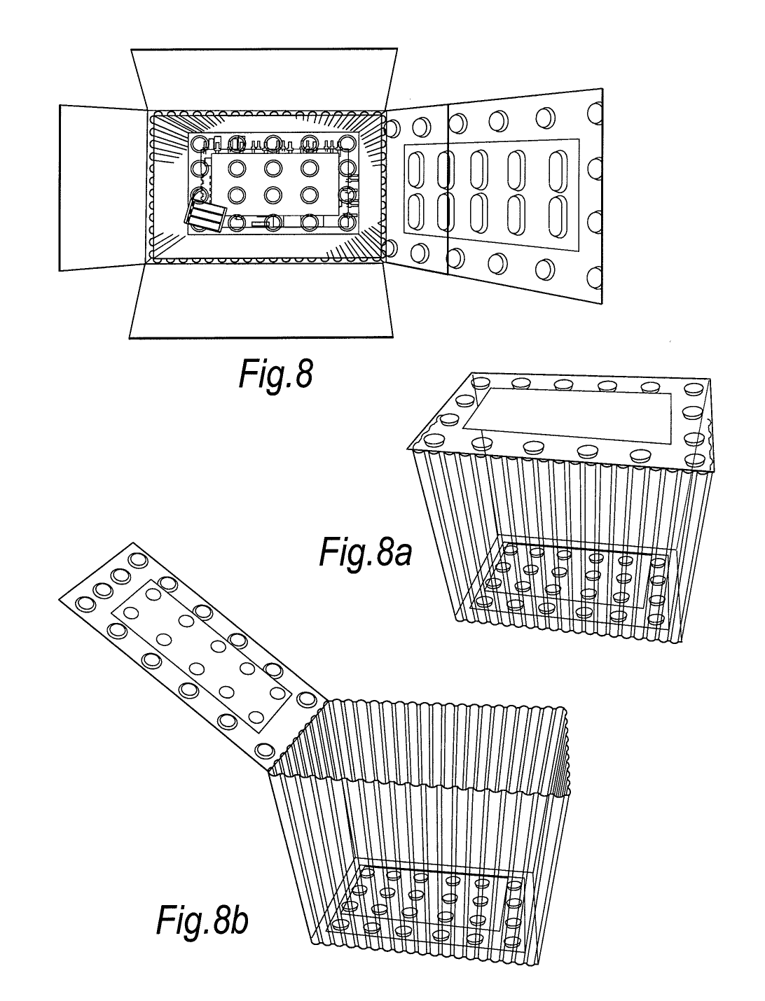

FIG. 7 shows a further single element insert formed from an expanded thermo plastics with base, sides and top 51, 53-57 as before, separated by reduced section folds 72. The view is of the outside faces and has depressions 71 for the heaters, depressions 74 for the thermisters, depression 77 for the control circuit and depressions 78 and 79 for the for the power supplies. Depressions 71 and channels 73 define part of the manifold for the long sides whilst depressions 71 and channels 75 define part of the manifold for the short sides of the carton. The channels 73 and 75 are shown as being wave-like, but can be variously shaped to enable the wall, as a whole, to benefit from heated convection gases. As will be appreciated the channels are open for one face, but when placed in juxtaposition with the inside face of the transport container, then the open face of the channel will thereby become closed.

The foam panels of FIG. 7 can comprise, conveniently of a laminated construction, whereby, using different densities of foam a lightweight yet stiff structure can be provided and a degree of flexibility about the edges 72 when used repeatedly. Conveniently these can be provided by commercially available HCFC-free expanded Polyethylene sheet (LDPE), where there is a closed cell structure with extrusion skin. This provides a low water absorption and water-vapour transmission rate. The foam has a high resiliency and flexibility, excellent cushioning behaviour and excellent thermal insulation properties, with a temperature stability of −40 to +70° C. Commercially available foams of such construction are manufactured by companies such as Knauf Insulation Ltd., Sealed Air Inc. etc. It has also been found that when laminated panels of differing density are employed, there is a reduced tendency of the product panels to bow. Through an appropriate choice of materials, lightweight panels can be selected to provide a resilient container which can elastically deform and return to an original position, albeit in a limited fashion.

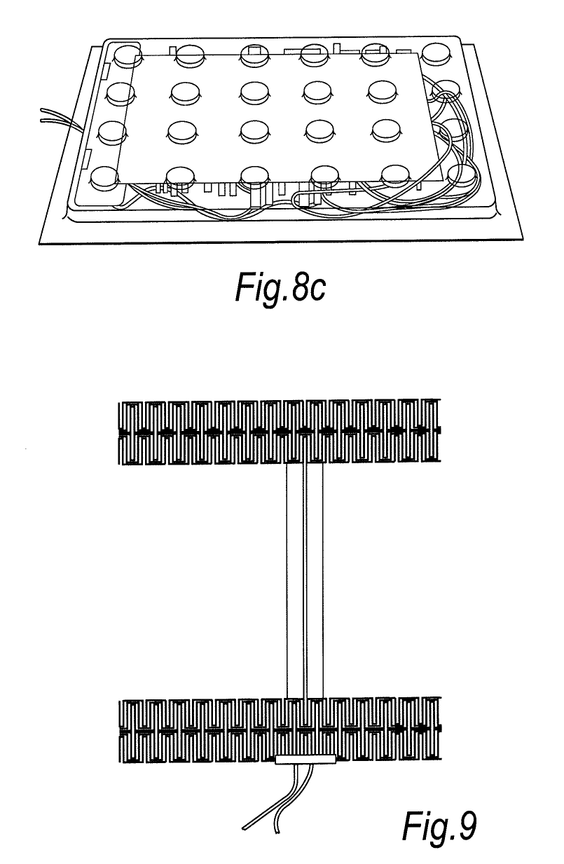

FIG. 8 shows a further embodiment; a cardboard box 80 has an insert 81 placed therein, the insert comprising an open-box-shaped container formed from polyvinyl chloride or similar types of plastics and has a lid. Heater elements 82, 83 are placed, respectively, in the lid and in the base; heater control electronics 84 are encapsulated within a resin and placed within a recess defined in the insert. The plastics insert being manufactured such that there are flutes within the wall whereby, when placed within a carton of corresponding dimensions, the flutes together with the inside walls of the carton define a convection channels. Such channels directly cause the air of the to move around the walls of the carton-insert interface to create a thermal jacket, which works to halt further heat reduction from the product volume and to balance the thermal energy lost by the carton to the atmosphere external to the carton. Temperature sensors are conveniently placed in a number of locations in the box; it has been found that it is sufficient to place two temperature sensors at opposite diagonally opposite corners, with a third sensor placed along one side of the box.

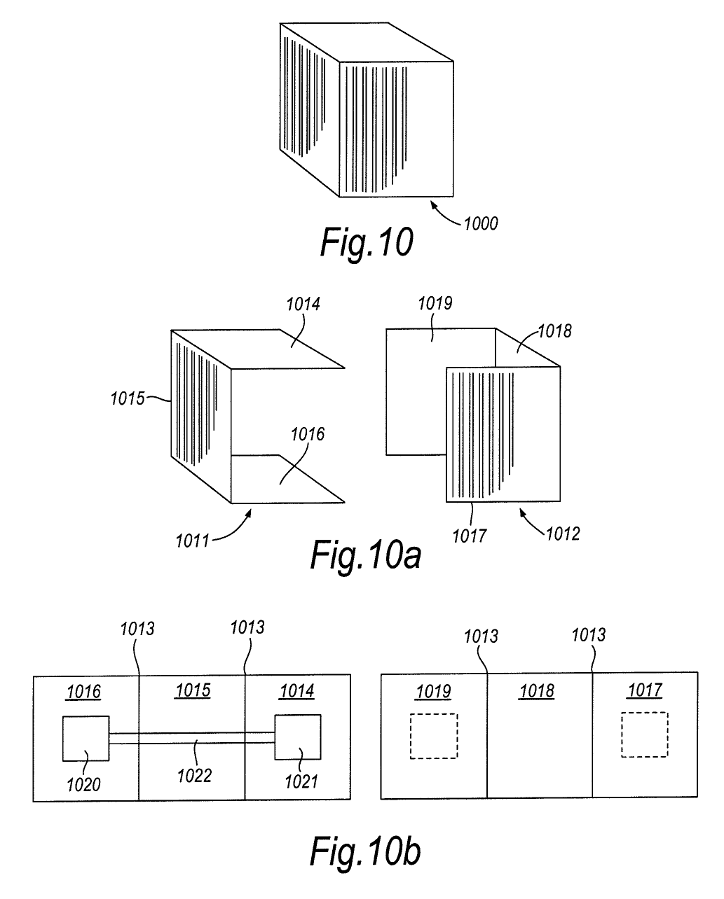

FIGS. 8a & 8b shows the insert 81 with heater elements 83, and 83, with the lid 85 in a closed position and an open position, respectively. FIG. 8c shows a heater pad overlying a control circuit, conveniently placed in the base of the insert. FIG. 9 shows an alternative polyester heater element, with a flexible ribbon wire connection from a first heater section to a second heater section.

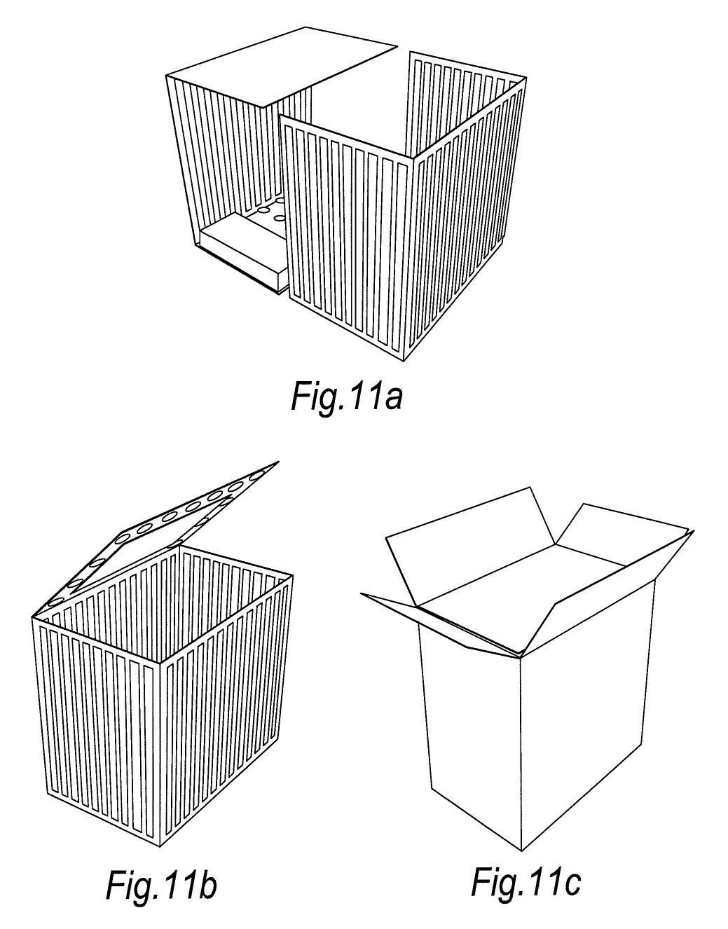

FIG. 10 shows a still further embodiment of the invention, wherein the temperature controller insert is formed of two sheet material elements. A box 1000 is formed from two sheet material sections 1011 & 1012, each having two folds 1013 defined parallel with two opposite edges. In this case a simple cubic box is shown, but the principle of manufacturing two inserts is not limited to such a shape; indeed, one could form an oval cylindrical box from two initially flat sheet members; a first sheet having two oval sections either end of a rectangular side portion, the other section comprising a rectangular sheet having a length corresponding to the length of the rectangular side portion and having a width suitable for surrounding the oval sides not comprising the rectangular section of the first member.

FIG. 10a shows how a first sheet 1011 can form: a top face 1014, a first side face 1015 and a base 1016 and a second sheet 1012 can form: a second side face 1017, a third side face 1018 and a fourth side face 1019. The sheet materials are conveniently formed from a moulded/formed plastics which provide recesses for control and heating mechanism, provide rigidity to the structure, enable content to be placed within an assembled carton, and provide channels or flutes for thermal currents to enable temperature equalisation to occur. FIG. 10b show first and second elements arranged in a single plane; the first element 1011 having a control circuit and first heater 1020, heating circuits complete with connecting wire.

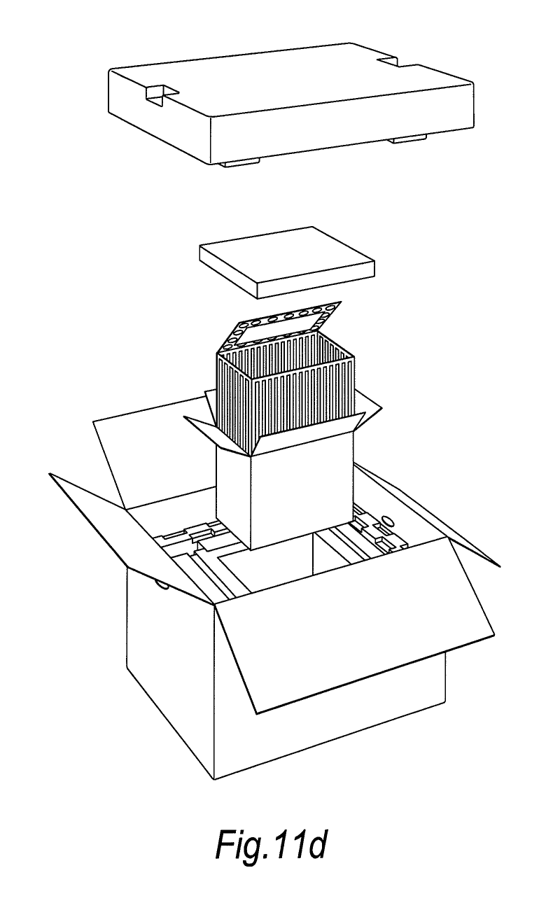

FIGS. 11a-11d relate to specific implementations of this further embodiment. FIG. 11a shows how the two generally “C”-shape elements can be brought together; FIG. 11b shows how the lid with heater can open at the top; FIG. 11c shows how the arrangement acts as a snug liner within a carton for normal use; FIG. 11d shows how the present invention can be packed for a winter delivery system.

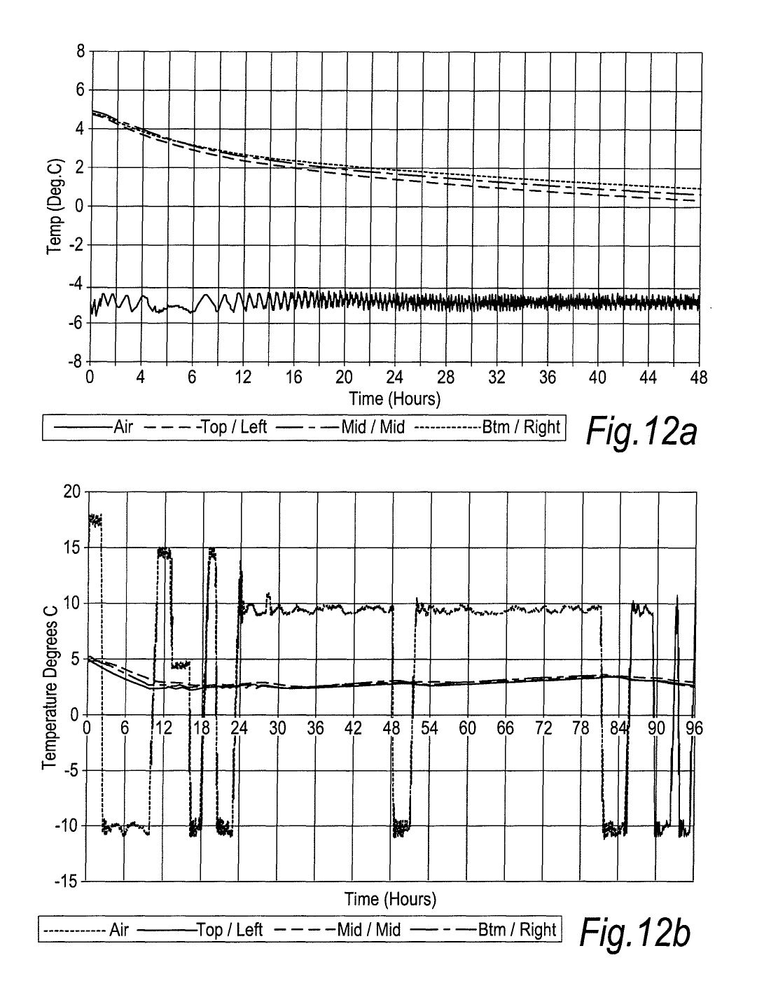

Referring now to FIGS. 12a & b, there are shown a couple of graphs to illustrate how the present invention can protect goods packaged within an insert inside a carton or box against the threat of low temperatures for a duration of 96 hours. FIG. 12a comprises a graph of temperature profiles: i) outside the carton; ii) inside—base; iii) inside—mid position; and, iv) inside top position over a period of forty-eight hours, without any control system. In the utilisation of the present invention, the aim is to provide a minimum temperature—in this case +2° C.—as demonstrated with reference to FIG. 12b, which shows a general indication of how the present invention may operate in a given carton or container over an industry performance standard referred to as the Winter Extreme Low profile, against which units are tested against.

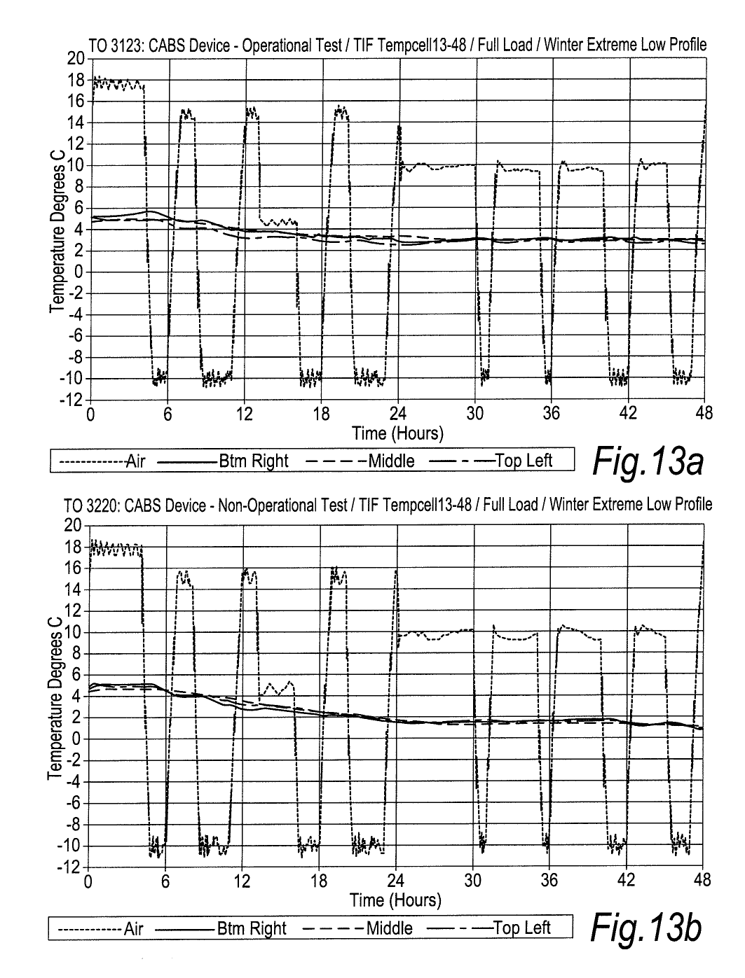

FIGS. 13a and 13b show a direct comparison of how a temperature profile varies within a transport carton with the present invention and without the benefit of the present invention in a temperature controlled room in accordance with international temperature control tests and procedures, in a simultaneous test. The temperature range is from −11° C. to +18° C. and cyclic in nature for a period of 48 hours, a typical door-to-door delivery period from factory to end-user. With reference to FIG. 13a, simply put, the present invention prevents temperature decline of a product; gaseous convection currents cause transfer of heat whereby to maintain the inside temperature of the transport carton above an operational minimum temperature. With reference to FIG. 13b, without the thermal stability scheme of the present invention, it can be seen that after only 24 hours, the internal temperature within the transport container has gone below the 2° C. limit. It will be appreciated that the invention can be deployed in other scenarios where a larger electrical energy storage system can enable larger cartons to be kept within a specified temperature range, with regard to a temperature increase as well as a temperature drop.

The system is simple to fabricate; temperature control can be simply implemented and by the use of suitable heaters and electrical energy storage cells can enable simply

The invention provides a simple to fabricate carton or box which can retain goods reliably at a specified temperature due to the use of suitable agents, such as gel packs with high thermal capacities, together with the inherently low thermal conductivity of the container and good levels of sealing between panels for a substantial degree of ordinary usage. However, a powered monitor system is provided whereby to ensure that extreme temperature excursions in transport can be prevented by a simple to use container insert. Datalogging also helps to confirm any temperature variations for confirmation and diagnostic purposes for an associated transport company, dispatcher or end-user. As will be appreciated, simple variants can be enabled with the use of S-D cards, usb ports or other communication systems.

1. A transport carton having an inside base, at least one inside wall from the base a cover and a temperature control system, the system comprising an insert that is operably inserted within the carton and including a base panel, at least one side wall panel, a heater, temperature sensing means and a control unit;
Wherein the heater is arranged within at least one of the base and one side wall of the insert;
Wherein the temperature sensing means is arranged to measure the temperature of at least one position within the one and the control means is arranged to cause the heater to operate upon meeting a threshold;
Wherein the base panel and at least one side wall panel of the insert define a convection manifold, such that upon operation of the heater, gaseous convection currents cause transfer of heat whereby to maintain the inside temperature of the transport carton above an operational minimum temperature.

2. A transport carton according to claim 1, wherein the insert is manufactured from moulded plastics, corrugated plastics or fibreboard.

3. A transport carton according to claim 1, wherein the insert comprises two or more separate planar elements that are folded or otherwise deformed to define an interior.

4. A transport carton according to claim 1, wherein the temperature sensing means comprises at least one thermister.

5. A transport carton according to claim 1, wherein the temperature sensing means comprises a thermister located within the base and is thermally isolated from the heater

6. A transport carton according to claim 1, wherein the temperature sensing means comprises several thermisters each located separately about the container.

7. A transport carton according to claim 6, wherein the temperature sensing means comprises several thermisters each located separately about the container and wherein a breach of a temperature threshold is determined by an algorithmic determination of the temperature as calculated from at least two thermisters.

8. A transport carton according to claim 1, wherein the insert comprises a cover panel.

9. A transport carton according to claim 1, wherein the convection manifold is determined, at least in part by channels of corrugation defined in the inserts.

10. A transport carton according to claim 1, wherein the inserts comprise moulded insulating plastics material, which define passages for convection of gases.

11. A transport carton according to claim 1, wherein the passages for the convection of gases are defined between an inside face of the carton and corrugations/rebates in a surface of an insert wall.

12. A transport carton according to claim 1, wherein the heater is disposed within the base of the insert.

13. A transport carton according to claim 1, wherein the heater is disposed within one or more side walls.

14. A transport carton according to claim 1, wherein the control means comprises a data logging device

15. A transport carton according to claim 1, wherein the control means comprises a wireless transmitter.

16. A thermally insulating transport carton according to claim 1, wherein the container is one of a rectangular box, a box having a round cross-section, a box having an oval cross-section or a box having a polygonal cross-section.

17. A thermally insulating transport container according to claim 1, wherein the container comprises a cardboard box.

18. A temperature control insert system for use in a transport carton or box according to claim 1.

19. A method of operating a transport carton having an inside base, at least one inside wall from the base a cover and a temperature control system, the system comprising an insert that is operably inserted within the carton and including a base panel, at least one side wall panel, a heater, temperature sensing means and a control unit; Wherein the heater is arranged within at least one of the base and one side wall of the insert; Wherein the temperature sensing means is arranged to measure the temperature of at least one position within the one and the control means is arranged to cause the heater to operate upon meeting a threshold; Wherein the base panel and at least one side wall panel of the insert define a convection manifold, such that upon operation of the heater, gaseous convection currents cause transfer of heat whereby to maintain the inside temperature of the transport carton above an operational minimum temperature;
The method comprising the steps of:
measuring the temperature at at least one position;
operating the heater when the temperature sensor determines that the temperature is below a threshold;
generating heated gaseous currents to cause transfer of heat; and,
allowing convection currents to pass heat via convection manifolds whereby to maintain the inside temperature of the transport carton above an operational minimum temperature.
